(19) United States
(12) Patent Application Publication
(10) Pub. No.: US 2005/0034588 A1
(43) Pub. Date: Feb. 17, 2005

(54) Separating-sheet dispenser, and dispensing method for dispensing separating sheets

(75) Inventors: Heinrich Schone, Balingen (DE); Wilhelm Huonker, Rosenfeld (DE); Rainer Seemann, Geislingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Bizerba GmbH & Co. KG, Balingen (DE)

(21) Appl. No.: 10/876,027

(22) Filed: Jun. 24, 2004

(30) Foreign Application Priority Data
Jun. 27, 2003 (DE) 103 29 842.8

(51) Int. Cl. B27B 5/02; B27B 29/04; B26D 7/06; B65H 9/04; B27B 31/04

(52) U.S. Cl. 83/707

(57) ABSTRACT

A separating-sheet dispenser for cut slices, in particular for sliced foodstuff, is provided, such dispenser comprising a holder for separating material, a cutting device for producing separating sheets, and a transporting device with at least one rotatable transporting roller for transporting web-like separating material, wherein the at least one transporting roller is positioned toward a deflecting device for cut material.

The present disclosure relates to the subject matter disclosed in German application No. 103 29 842.8 of Jun. 27, 2003, which is incorporated herein by reference in its entirety and for all purposes.

### BACKGROUND OF THE INVENTION

The invention relates to a separating-sheet dispenser for cut slices, in particular for sliced foodstuff, comprising a holder for separating material, a cutting device for producing separating sheets, and a transporting device with at least one rotatable transporting roller for transporting web-like separating material.

Such separating-sheet dispensers are also referred to as interleavers.

The invention also relates to a dispensing method for dispensing separating sheets between cut slices, in particular sliced foodstuff, in the case of which a separating-material sheet is deposited on a cut slice.

In particular in the case of foodstuffs with a high fat content, such as cheese, cheese-containing wurst or fat-containing wurst, there is a problem of slices which are set down one upon the other sticking together. In an attempt to separate them from one another, the slices may be pulled to pieces. In such cases, provision is thus made for separating sheets made of a plastics material or of greaseproof paper to be positioned between adjacent slices. In order to save time, such a separating-sheet dispensing operation should take place automatically. U.S. Pat. No. 2,813,798 discloses a method in which paper sheets are positioned between adjacent foodstuff slices, separating sheets produced being allowed to drop onto the slices along a substantially horizontal path.

### SUMMARY OF THE INVENTION

In accordance with the invention, a separating-sheet dispenser is provided that can easily be used in conjunction with a cutting machine for producing cut slices.

The at least one transporting roller is positioned toward a deflecting device for cut material. Such, this transporting roller is directed toward the deflecting device and, in particular, facing the deflecting device.

Since, according to the invention, the at least one transporting roller is directed towards a deflecting device, a separating sheet can be deposited on a cut slice irrespective of the spatial position of the cut slice. In particular, it is also possible for a cut slice to be supplied non-horizontally, and in particular vertically, and nevertheless for a separating sheet to be deposited on the cut slice.

Since the at least one transporting roller is positioned towards the deflecting device and, in particular, located opposite the latter (facing the latter), the separating-sheet dispenser can easily be fitted on a slicing machine or integrated in a slicing machine.

It is advantageous if the deflecting device can deflect cut material from a cutting plane into a transverse plane. In particular, it is thus possible for cut material to be transferred to a conveying device by means of which cut material can be guided away from a cutting blade for cutting material.

It is advantageous if the deflecting device has one or more carry-along elements for cut material. A carry-along element ensures that a cut slice is deflected from a cutting plane. Such a carry-along element may be formed, for example, as a sliding element. It may also be formed as a rotatable element which, in particular, is driven, in order thus to ensure deflection.

It is quite particularly advantageous if the deflecting device, as carry-along element, comprises a rotatable element, for example a roller. This roller can receive a separating sheet from the transporting roller and transport it further, in order for it to be possible for the separating sheet to be set down on the cut material.

It is further advantageous if the deflecting device is disposed and formed such that separating material can be carried along. A separating sheet can thus be transferred from the at least one transporting roller in order for it thus to be possible, once again, for the separating sheet to be set down on the cut material.

The at least one transporting roller is advantageously disposed and formed such that a separating sheet can be fed to the cut material on the deflecting device for cut material. A separating sheet can thus be set down on the cut material directly at the location where a cut slice is produced. The apparatus may thus be formed in a compact manner, in particular, by the combination of cutting machine and separating-sheet dispenser.

If the at least one transporting roller and the deflecting device are disposed and formed such that a separating sheet which has been cut off and fed to the cut material can be carried along by the cut material, this minimizes the design outlay for setting down the separating sheet and having it carried along by a cut slice. In this context, it is advantageous, in particular, if the separating material is formed such that the cut material is subjected to a sufficiently high adhesive force in order for a set-down separating sheet to be transported by the cut material itself.

It is provided that, located opposite the at least one transporting roller, a rigid element is disposed as counter element on the transporting device. The separating material is guided through between this counter element or the counter elements and the transporting roller or rollers. If the counter element is rigid, then the separating material can easily be gripped if it is not to be transported, in order, for example, for the separating material to be unrolled from a roll.

In particular, a separating sheet can be fed to a slice as it is being cut. This makes it possible to construct a compact apparatus. There is no need to ensure any interim storage of the cut slices which are to be provided with separating sheets.

In particular, an operation for feeding separating sheets to the cut material takes place synchronously with an operation for cutting the material.

It is advantageous if a conveying device is provided for transporting cut material away from a blade for material which is to be cut. It is thus possible for cut material to be moved away from the cutting region. At the same time, cut slices are retained in a defined position, which, once again, makes it easier for separating sheets to be set down.

It may be provided that the conveying device comprises a chain frame. One or more chains, on which cut slices can be, as it were, engaged in order to be transported, are movable on this chain frame.

In particular here, the at least one transporting roller is directed toward the conveying device. It is thus possible for a separating sheet to be set down on a slice during the cutting operation and transporting operation.

For the same reason, it is advantageous if the deflecting device is directed toward the conveying device. The deflecting device deflects a cut slice from the cutting plane into a transporting direction. A separating sheet can be deposited at the same time as this deflection is taking place.

In particular, a separating sheet can be fed to the cut material between the chain frame and the at least one transporting roller.

For the same reason, it is advantageous if a separating sheet can be fed to the cut material between the chain frame and the deflecting device for cut material.

It is quite particularly advantageous if the deflecting device is disposed and formed such that a separating sheet can be passed on from the at least one transporting roller to a carry-along element of the deflecting device. The deflecting device then ensures, on the one hand, that a cut slice is deflected. It is also ensured that a separating sheet is deflected, in order for the latter to be set down on the cut slice and for it to be ensured that it is carried along by the cut slice.

A rotatable element, as carry-along element of the deflecting device, and the at least one transporting roller advantageously have parallel axes of rotation, in order to ensure reliable transfer.

A conveying direction is substantially parallel to an axis of rotation of a circular blade for cutting material which is to be cut, in order to ensure transportation away from this circular blade.

Furthermore, a conveying direction is preferably substantially perpendicular to the axis of rotation of the at least one transporting roller. This makes it possible to achieve a compact construction.

It is further advantageous if the at least one transporting roller is disposed and formed such that a separating sheet can be deflected into a movement in a conveying direction for cut material from a movement in the transporting device transverse to the conveying direction. This results, once again, in a compact construction, in particular, of a combination of separating-sheet dispenser and slicing machine.

The at least one transporting roller is advantageously driven, in order to ensure transportation of the transporting material. It is then also possible to achieve the situation where the separating material can be gripped, in order, for example, for this material to be unrolled from a roll.

It may be provided, in principle, that the holder holds stacked separating material or separating material accommodated in a magazine. A space-saving formation can be achieved if the holder is formed for accommodating a roll of separating material. In this case, it is then possible for wound-up separating material for producing separating sheets to be unwound from a roll.

The at least one transporting roller advantageously has a planar region, in particular a flattened region, so that the transporting roller, rather than be circular in cross-section, corresponds to a circle from which a circle segment has been cut off. If this planar region is located parallel to a separating-material sheet, then the separating material can easily be pushed in between this planar region and a counter element. If the transporting roller then rotates to some extent, so that the round region is in abutment, the transporting material can then be reliably gripped in this way. Taking this as a basis, then, it is possible for the separating material to be unwound from a roll by the roll being moved away from the transporting roller.

The object mentioned in the introduction is also thus achieved if the holder for the separating-material roll is disposed on a linearly displaceable carriage. Displacement of the carriage allows separating material to be unwound, the separating material being tensioned at the same time. A compact construction may be achieved via a linearly displaceable carriage.

In particular, the carriage is guided such that it can be displaced in relation to the at least one transporting roller, it being possible for transporting material to be gripped via the transporting roller and, by virtue of the movement away from the transporting roller, for transporting material to be placed in position, and, in particular, unwound.

It is then advantageous if the carriage has one or more recesses like cutouts which are adapted to the at least one transporting roller in order to facilitate the gripping of the separating material by the transporting roller. If transporting material is located above this recess and the carriage is then displaced to the transporting roller, a counter element is located beneath the separating material in the region of the recess and a transporting roller is located above the separating material in the region of the recess. Gripping of the separating material is then simplified.

In particular, the carriage movement is driven and, in this case, driven in a controlled manner in order for it to be possible for separating sheets to be easily produced.

The carriage can be displaced, in particular, in a direction transverse to the axis of rotation of the at least one transporting roller. It is thus easily possible for transporting material to be unrolled and, at the same time, kept under tension.

It is further advantageous if the carriage can be displaced away from a cutting blade in a direction transverse to a conveying direction for cut material. It is then possible to achieve a compact construction for the apparatus.

For the same reason, it is advantageous if the carriage can be displaced transversely to an axis of rotation of a circular blade for cutting material.

It is likewise advantageous if the carriage can be displaced parallel to a displacement direction of an accommodating carriage for a material which is to be cut. This also allows a compact construction of an overall apparatus comprising a separating-sheet dispenser and a slicing machine with accommodating carriage.

The carriage is advantageously guided on a stop plate for material which is to be cut or on a plate which is parallel to the stop plate. This also makes it possible to achieve a compact construction.

It may also be provided that the carriage is guided on a housing part of a cutting machine.

In order to achieve a compact construction, the transporting device is fitted on the stop plate or the parallel plate. It is also possible for the transporting device to be fitted on a housing of a cutting machine, in particular slicing machine.

It is quite particularly advantageous if the deflecting device is fitted such that the spacing from the stop plate is fixed. Setting a spacing of the stop plate on a circular blade makes it possible to set a cut-slice thickness. If the transporting device is fitted on the stop plate, then this is carried along when the cutting thickness is set. If the spacing of the deflecting device from the stop plate is then fixed, the relative position between the transporting-roller device and the deflecting device does not change, so that the transfer function (deflecting function) both for cut material and for separating-material sheets is ensured irrespective of the position of the stop plate. Such a fixed relationship in the spacing between the stop plate and the deflecting device can be achieved if the deflecting device is disposed and formed such that it is displaced along as well when the stop plate is displaced. Such an arrangement and formation is known from the prior art.

It is preferably provided that the deflecting device is fitted on the conveying device. The task of the deflecting device, of deflecting cut slices to the conveying device, can thus be reliably carried out.

Via the carriage movement, separating material can advantageously be placed in position between the at least one transporting roller and the holder and, in particular, unrolled, if the separating material has been wound up onto a roll. A linear movement of the carriage then causes separating material to be unrolled and, at the same time, kept under tension.

The cutting apparatus is advantageously mounted on the carriage. The cutting movement can then easily be carried out, it being possible for this to be done, in particular, automatically by a mechanical control means. If the cutting device comprises a cutting blade which is guided in a vertically displaceable manner on the carriage, then a separating sheet can be cut off precisely and easily. The cutting blade is, in particular, a serrated blade.

It is then advantageous if the carriage has a groove for the penetration of a cutting blade of the cutting device. The groove acts as a counter element to the cutting blade. This makes it possible to improve the cutting result.

It is quite particularly advantageous if a positioning device, in particular a mechanical positioning device, is provided, by means of which a cutting blade can be moved into a high-level position and can be fixed there and by means of which this high-level position can be released in order for a cutting movement to be initiated. In the high-level position of the cutting blade, the separating material is freed in order for it to be possible for it to be gripped and for separating material to be unrolled from a roll. Starting from this high-level position, a cutting movement can be carried out by virtue of the cutting blade being displaced.

Such a positioning device can easily be realized by the provision of a ramp by means of which the cutting blade can be moved into its high-level position. By virtue of a carriage movement, the cutting blade can thus be automatically moved into its high-level position and secured there.

In particular, the ramp is disposed and formed such that the cutting blade can be moved into its high-level position when the carriage moves in the direction of the at least one transporting roller. The movement in the direction of the transporting roller takes place, in particular, when a separating sheet has been severed and is dispensed; in order to produce a new separating sheet, more separating material has to be unrolled. Following movement of the carriage in the direction of the at least one transporting roller, the separating material, once again, can be gripped by the transporting roller and secured, in order to ensure an unwinding operation. With the ramp being formed correspondingly, the cutting blade can be automatically moved into its high-level position again.

The movement of the cutting blades to execute a cutting movement can easily be driven if the cutting blade is subjected to the action of a spring. The spring force here acts in the direction of the separating material. The high-level position can then easily be secured by the movement of the cutting blade towards the separating sheet being blocked. Such blocking, once again, can easily be released in order that the spring force can initiate a cutting movement.

The positioning device advantageously comprises a stop for the carriage, via which it is possible to release a cutting-blade movement in the direction of unrolled separating material in order to sever a separating sheet. The stop here acts on the cutting blade such that the blocking in the high-level position is eliminated.

In particular, the stop can be displaced and fixed in order to set the separating-sheet length. In combination with a displaceable carriage, and along with low design outlay, the separating-sheet length can be set within a large length range, which is determined substantially by the displacement length and the stop of the carriage.

In particular, the carriage movement is synchronized with the separating-sheet dispensing operation. It is thus possible for example, once a separating sheet has been produced, for the latter to be dispensed. During or after the dispensing operation, it is simultaneously possible for measures to be taken in order to produce a new separating sheet, by virtue, in particular, of the carriage being displaced correspondingly.

In particular, during a separating-sheet dispensing operation, the carriage is displaced in the direction of the at least one transporting roller in order thus to prepare the production of a new separating sheet.

A sensor is advantageously provided for detecting at least one end position of the carriage. It may be provided here that this sensor is coupled to a stop for initiating the cutting movement. This sensor can detect at least one end position of the carriage, in order thus for it to be possible to ensure synchronization of the operations of producing and feeding separating sheets.

It is possible here to provide a sensor by means of which it is possible to determine the position of the carriage relative to the at least one transporting roller and, in particular, to determine this in absolute terms. This sensor may be, for example, an inductive length sensor or an optical length sensor. It may also be an inductive angle sensor or the like. A control and regulating device then has, at all times, information regarding the position of the carriage, in order thus for it to be possible to ensure optimum control and regulation of a separating-sheet dispensing operation and of the separating-sheet dispensing production.

The separating-sheet dispenser according to the invention can be used in conjunction with a slicing machine. In particular, this slicing machine is provided with a conveying device for cut slices.

The slicing machine according to the invention comprises, in particular, a driven circular blade for producing slices. Also provided is a displaceable accommodating carriage, in particular an automatically displaceable accommodating carriage, for material which is to be cut. It is also possible to provide a stop plate for material which is to be cut, the separating-sheet dispenser, once again, being fitted on this stop plate.

Slicing machines which may be provided with a separating-sheet dispenser according to the invention are described, for example, in WO 96/05952 and EP 0 827 816 A1, which are incorporated by reference.

In accordance with the invention, a dispensing method is provided which can be used universally.

In accordance with the invention, a separating sheet is fed to the cut material between a conveying device for cut material and a deflecting device for cut material.

The method according to the invention has the advantages which have already been explained in conjunction with the apparatus according to the invention.

Since the feeding operation takes place between the conveying device for cut material and the deflecting device, a separating sheet can be set down in a defined manner, in particular immediately after the cut material has been produced. A corresponding apparatus may be of compact construction.

Further advantageous configurations of the method according to the invention have already been explained in conjunction with the apparatus according to the invention.

In particular, a separating sheet is dispensed as a slice is being cut. There is thus no need to ensure, for example, any interim storage of cut slices on which separating sheets are to be set down.

In particular, separating material is fed to the deflecting device via at least one transporting roller. The transporting roller may be disposed in the vicinity of the deflecting device. At the same time, the deflecting device can then itself ensure transportation of the separating material.

In particular, it is then provided that the at least one transporting roller grips separating material in order to unwind it from the roll. This gripping takes place during a period of time over which separating material is not being dispensed.

It is advantageous if an angular position of the at least one transporting roller is controlled such that the separating material can be gripped. This is advantageous when the transporting roller is not rotationally symmetrical and, in particular, has a flattened portion in order to facilitate gripping.

It is further advantageous if the separating material is unwound between the at least one transporting roller and the roll in that a carriage with the roll moves away from the at least one transporting roller. When a certain carriage position is reached, a separating sheet is then preferably cut off automatically, this cutting movement being coupled to the end position being reached.

In particular, the operations of producing and feeding separating sheets are synchronized with a cutting operation for producing cut material.

The following description of a preferred exemplary embodiment serves to explain the invention in more detail in conjunction with the drawings.

### BRIEF DESCRIPTION OF THE DRAWINGS

FIG. 1 shows a schematic lateral view of an exemplary embodiment of a separating-sheet dispenser according to the invention which is fitted on a slicing machine;

FIG. 2 shows a schematic illustration, in perspective, of elements of the separating-sheet dispenser according to FIG. 1;

FIG. 3 shows a schematic illustration of the separating-sheet dispenser according to FIG. 1 in the direction A (from beneath);

FIG. 4 shows a schematic illustration of the separating-sheet dispenser according to FIG. 1 in the direction B (from above); and

FIG. 5 shows an enlarged illustration of a cutting region of the slicing machine with the separating-sheet dispenser.

### DETAILED DESCRIPTION OF THE INVENTION

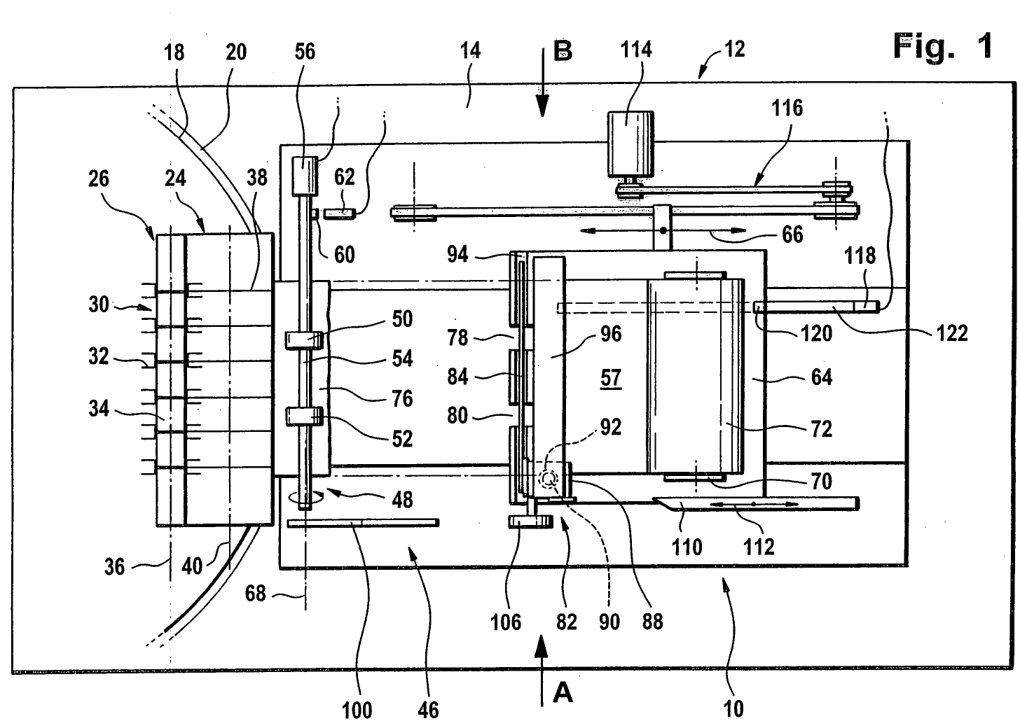

An exemplary embodiment of the separating-sheet dispenser according to the invention, which is shown in its entirety in FIG. 1 and is designated 10 there, is associated with a foodstuff-cutting machine 12. Such foodstuff-cutting machines are also referred to as slicing machines. Examples of such slicing machines are described in WO 96/05952 or EP 0 827 816 A1, to which you are expressly referred. They can be used to produce slices from blocks of foodstuff such as wurst or cheese.

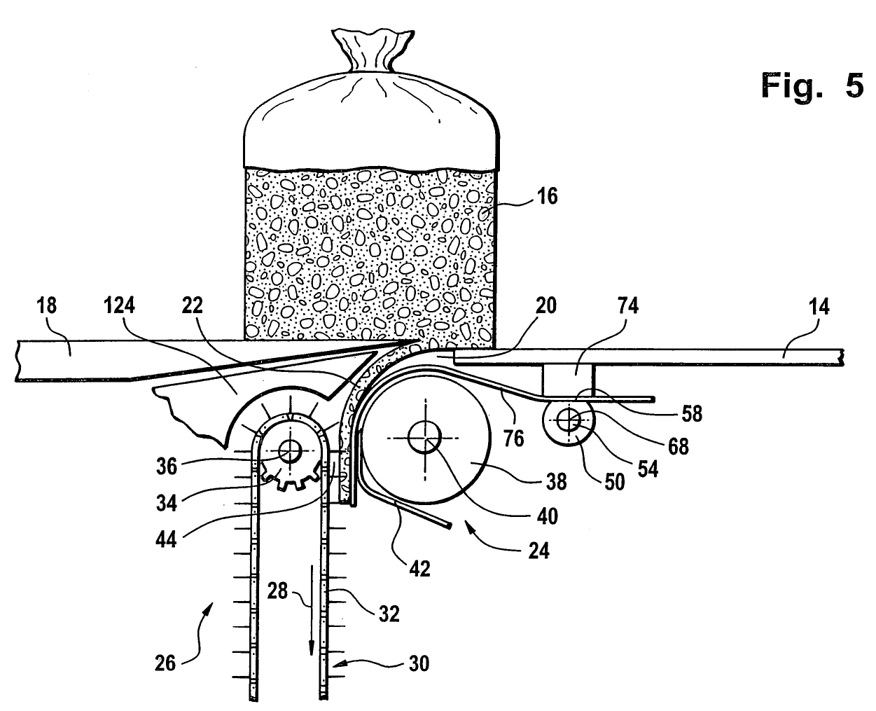

The separating-sheet dispenser 10 according to the invention may be placed alongside the foodstuff-cutting machine 12 or fitted thereon. In the case of the exemplary embodiment shown in FIG. 1, the separating-sheet dispenser 10 is fitted on a stop plate 14 for a material which is to be cut. During cutting of a block 16 of foodstuff (FIG. 5), this block is retained on an accommodating carriage and is guided in a longitudinally displaceable manner parallel to the stop plate 14. The thickness of the slices can be set via the stop plate 14. A cutting plane for the cutting material here is parallel to the stop plate 14. The separating-sheet dispenser 10 is fitted on that side of the stop plate 14 which is located opposite the stop side for the block 16 of foodstuff.

The slicing machine 12 comprises a circular blade 18 which can be rotated about an axis of rotation which is perpendicular to the stop plate 14. In FIG. 1, this axis of rotation is perpendicular to the plane of the drawing.

A gap 20, through which a cut slice 22 (FIG. 5) can be removed, is formed in the stop plate 14 or at the end of the stop plate 14.

In order to remove cut slices 22 from the circular blade 18, a deflecting device 24 is provided, the latter deflecting a cut slice 22 from the cutting plane (parallel to the stop plate 14) into a transverse plane and, in particular, discharging a cut slice 22 to a conveying device 26, via which cut slices 22 can be transported away from the circular blade 18. A conveying direction 28 of the conveying device 26 here is located substantially parallel to the axis of rotation of the circular blade 18 (FIG. 5).

The conveying device 26 may comprise a chain frame 30, on which a plurality of spaced-apart chains 32 are guided parallel to one another. The chains here are driven via a chain roller 34. An axis of rotation 36 of such a chain roller is located perpendicularly to the conveying direction 28.

The chains are formed such that they can carry along cut slices 22. In particular, the chains have outwardly oriented chain spikes by which the cut slices can be engaged in order to carry them along.

The deflecting device 24 is located opposite the chain frame 30 of the conveying device 26 and directed towards the same. As carry-along elements, it comprises, for example, rotatable elements such as a plurality of spaced-apart rollers 38 which are toothed on the outer circumference. The rollers 38 have a common shaft, so that they can be jointly rotated synchronously about an axis of rotation 40, which is parallel to the axis of rotation 36.

It is also possible for a carry-along element to be formed in a non-rotatable manner, for example as a sliding element which ensures that a cut slice is fed to the conveying device 26.

The toothing formations of the rollers 38 are formed such that they force cut slices 22 onto the chain spikes. The rollers 38 are driven synchronously with the chain rollers 34 by a geared connection.

As is described in more detail hereinbelow, the rollers 38 can also carry along a separating sheet in order to set it down on a cut slice 22.

The deflecting device 24 comprises a stripping element 42 (FIG. 5), which partially encloses the rollers 38. This stripping element 42 has cutouts in order that chain spikes can penetrate between adjacent rollers 38 in order to ensure that the cut slices are transferred onto the conveying device 26. The stripping element 42 is produced from a material which has low forces of adhesion in respect of cut slices 22. It ensures that cut slices 22 are deflected by the deflecting device 24 onto the conveying device 26 and are not carried along by the rotating rollers 38 and guided away from the conveying device 26. For this purpose, this stripping element 42 is disposed, in particular, in a region in which there is a risk of a cut slice 22 being released again from the conveying device 26 or of setting down on the conveying device 26 being prevented.

In particular, the stripping element 42 is introduced into an interspace 44 between the conveying device 26 and the deflecting device 24, through which a cut slice 22 is transported. In and in front of this interspace 44 (directed towards the circular blade 18), the cut slice is deflected from the cutting plane into the conveying direction 28.

The separating-blade dispenser 10 comprises a transporting device which is designated as a whole by 46, the rollers 38 also having a transporting function for separating sheets, as is described in more detail hereinbelow.

Directed towards the deflecting device 24 is a transporting-roller device 48 (FIG. 1) which, in the exemplary embodiment shown, comprises a first transporting roller 50 and a second transporting roller 52, which are seated on a common driven shaft 54. The shaft 54 is driven by a motor 56, in particular an electric motor.

The two transporting rollers 50 and 52 serve for gripping and for transporting a separating-material web 57. They are produced, for example, from rubber. The transporting rollers 50, 52 here comprise a flattened, in particular planar region 58 (FIG. 5) which, as is described in more detail hereinbelow, facilitates the gripping of the separating material. Rather than being circular, the cross-sections of the transporting rollers 50 thus correspond to a circle from which a circle segment has been cut off.

For the precise positioning of this flattened region 58 of the two transporting rollers 50, 52, the flattened regions of the two transporting rollers 50, 52 being aligned parallel to one another, the shaft 54 is provided with a marking 60. Via a sensor 62, which is aligned with that region of the shaft 54 which carries the marking 60, the flattened region 58 can then be positioned precisely in relation to the separating material.

The separating-sheet dispenser 10 comprises a linearly displaceable carriage 64 which is guided in a movable manner on the stop plate 14. As an alternative, provision may also be made for the carriage to be guided in a displaceable manner on a plate positioned parallel to the stop plate 14. A movement direction 66 of this carriage 64 is located transversely, in particular perpendicularly, to an axis of rotation 68 of the transporting rollers 50 and 52, this axis of rotation 68, once again, being parallel to the axes of rotation 36 and 40. The movement direction 66 of the carriage 64 here is, in particular, parallel to a movement direction of an accommodating carriage for a material 16 which is to be cut on the slicing machine 12. The carriage 64 can be moved in the direction of the transporting-roller device 48 and away from the same.

The carriage comprises a holder 70 for a separating material which is in the form of a web and has been wound up, for example, to form a roll 72. The roll 72 is then retained by the holder 70. It is also possible, however, for the separating material to be retained as a stack or to be supplied from a magazine. The holder is then formed correspondingly.

Web-like separating material 57 is unwound from the roll 72 between the transporting-roller device 48 and the holder 70. For gripping the separating material here, located opposite the transporting-roller device 48 are one or more counter elements 74 (FIG. 5) which are disposed in a rigid manner, in particular in a non-rotatable manner, in relation to the stop plate 14. Web-like separating material 57 is guided through between the counter element or elements 74 and the transporting-roller device 48 with its transporting rollers 50 and 52.

The separating material is a material which is suitable for separating cut slices 22 from one another. In particular, this material has to be suitable for separating fat-containing slices of foodstuff from one another. Greaseproof paper is a possible material. Use is preferably made of a plastics film or sheet material.

At its end which is directed towards the transporting-roller device 48, the carriage 64 has recesses 78, 80 like cutouts which are adapted to the associated transporting rollers 50, 52 with their respective counter elements 74. These recesses 78, 80 make it possible for the carriage 64 to be displaced in relation to the transporting-roller device 48, via the transporting roller 50, 52 with their counter elements 74, such that the transporting rollers 50, 52 are located above the carriage 64 with the separating material 57, in order for it to be possible for the latter to be gripped more easily. This is described in more detail hereinbelow.

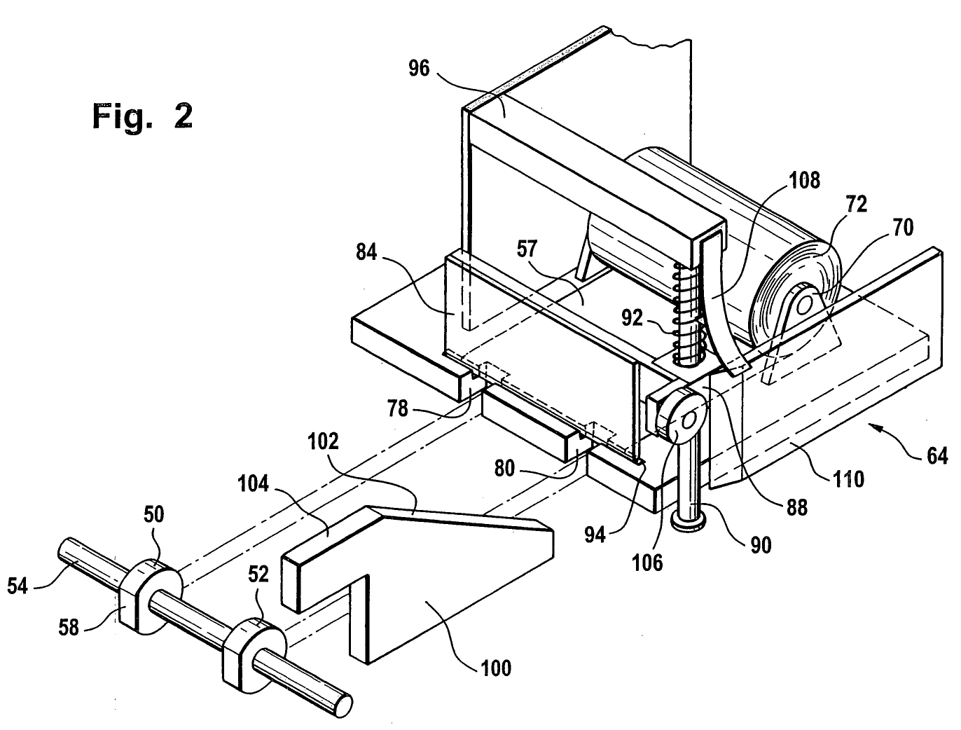

The carriage 64 is provided with a cutting device which is designated as a whole by 82 and via which separating-material sheets for dispensing for the cut slices 22 can be produced from the separating material 57. The cutting device 82 comprises a cutting blade 84 which is disposed in a vertically displaceable manner on the carriage 64 (FIGS. 1 to 4).

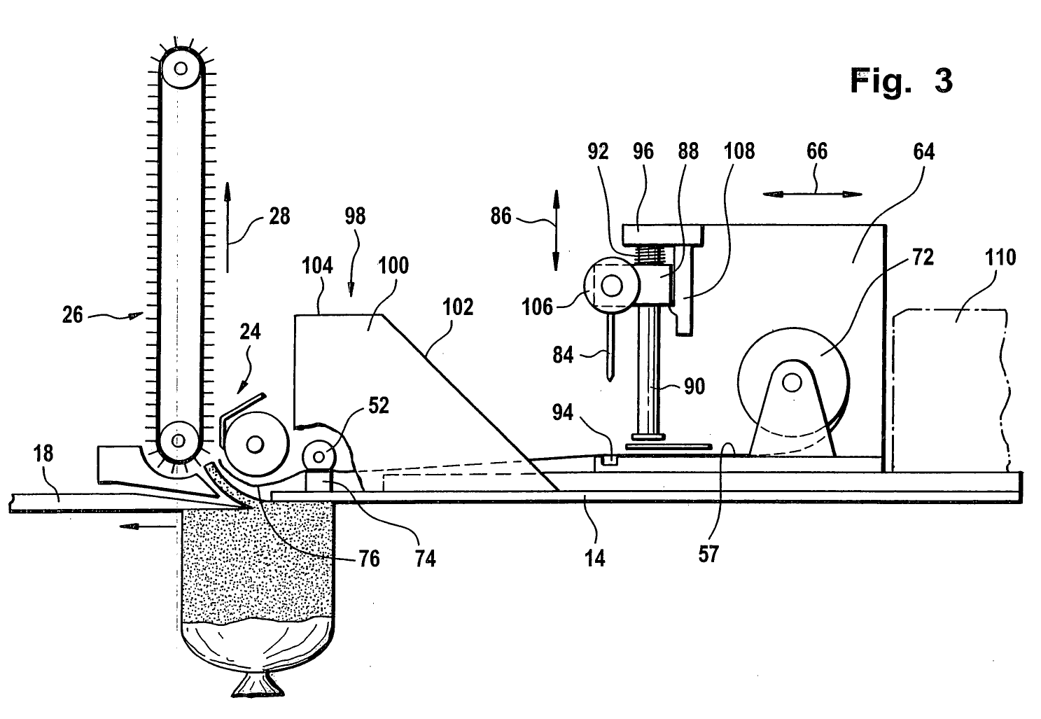

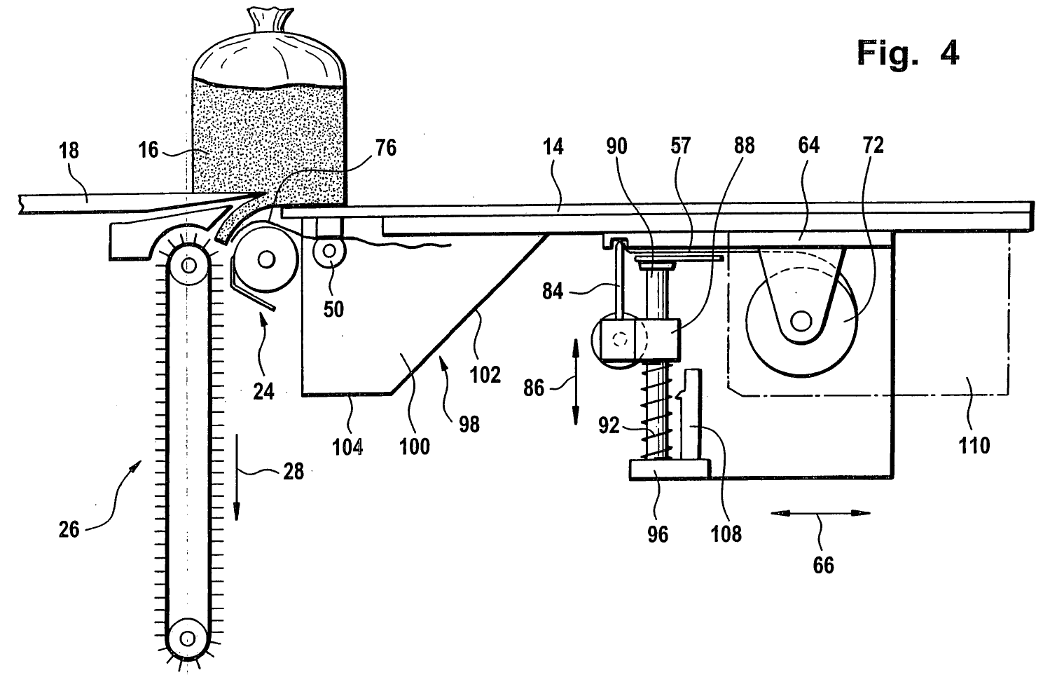

A displacement direction 86 of the cutting blade 84 here is transverse, in particular perpendicular, to the movement direction 66 of the carriage 64 (FIGS. 3 and 4). The cutting blade 84 is retained on a blade carriage 88, which can be displaced in this direction. The blade carriage 88 is guided on a guide 90 that extends transversely, in particular perpendicularly, to the stop plate 14. The carriage 88 itself is subjected to the action of a spring 92, the spring force of which acts in the direction of the stop plate 14 when the spring 92 is compressed. If the spring 92 is released, then it drives the blade carriage 88, and thus the cutting blade 84, in the direction of the separating-material sheet 57, in order to sever the latter and thus produce a separating sheet 76.

The carriage 64 is preferably provided with a groove 94 in the region of the cutouts 78, 80. This forms a counter element for the cutting blade 84, in order to improve the cutting action of the latter.

The spring 92 is supported on a supporting element 96 which is disposed at an end of the guide 90 which is directed away from the stop plate 14.

According to the invention, a positioning device 98 is provided for the cutting blade 84, which is formed in particular as a serrated blade, the positioning device allowing the cutting blade 84 to be positioned automatically and allowing a cutting movement to be executed automatically. For this purpose, the positioning device 98 comprises a ramp 100, which is disposed in relation to the transporting-roller device 48 such that, when the carriage 64 is moved in the direction of the transporting-roller device 48, the cutting blade 84 can be moved into a high-level position and secured there. The ramp 100 is thus disposed in the vicinity of the transporting-roller device 48 and has an upward slope 102 in the direction of the transporting-roller device 48 (and in the direction of the deflecting device 24). A flat region 104 is preferably provided, this flat region adjoining the upward slope 102 and being formed such that the cutting blade 84, in its high-level position (which is shown schematically in FIG. 3), is located above the transporting rollers 50, 52.

The blade carriage 88 of the cutting device 82 is aligned with the ramp 100 and has a rolling element 106 which can roll on the ramp 100, in particular on the upward slope 102 thereof. If the carriage 64 is moved in the direction of the ramp 100, then the rolling element 106 rolls up the upward slope 102 and, in the process, results in the height of the blade carriage 88 of the cutting device 82 rising relative to the stop plate 14. The spring 92 is thus compressed, i.e. the spring force has to be overcome. This force stems from the driven movement of the carriage 64.

When the definitive high-level position has been reached, this being predetermined by the transition from the upward slope 102 into the planar region 104, then the high-level position is secured, i.e. fixed. A securing element 108 is provided for this purpose, this element being disposed in a fixed manner in relation to the supporting element 96 of the carriage 64 and engaging in the blade carriage 88 of the cutting device 82, in order to block the movement thereof in the direction of the stop plate 14. For example, a resilient plate or the like is provided as securing element 108.

The securing element 108 can be released via a stop element 110. This stop element 110 (FIGS. 1 to 4) is formed such that, when the carriage 64 reaches this stop element 110 in a suitable position, the stop element guides the securing element 108 away from the blade carriage 88 and thus eliminates the blocking of the vertical displaceability in the direction of the stop plate 14. This is shown schematically in FIG. 4: by virtue of the securing element 108 being released, the spring 92 drives the blade carriage 88, and thus the cutting blade 84, in the direction of the stop plate 14 and causes the separating material 57 to be severed, in order thus for a separating sheet 76 to be produced.

The stop element 110 is disposed, in particular, such that it can be displaced in relation to the stop plate 14, as is indicated in FIG. 1 by the arrows 112. By virtue of it being possible for the stop element 110 to be displaced and fixed, it is possible to set the length of a severed separating sheet 76: the greater the distance between the stop element 110 (in the movement direction 66 of the carriage 64) and the transporting-roller device 48, the greater the length of a severed separating sheet 76.

The carriage 64 is driven via an electric motor 114, a belt drive 116 also being provided, in particular, for converting a rotary movement of a motor shaft into a linear movement of the carriage 64.

In order to detect an end position of the carriage 64, it is possible to provide a sensor 118, for example a Halle-effect sensor. In this case, a magnet 120 is disposed on the carriage 64. The sensor 118 can preferably be displaced together with the stop element 110.

It is also possible to provide a sensor 122 by means of which the absolute position of the carriage in relation to the transporting-roller device 48 can be established. This sensor may be, for example, an inductive sensor or an optical sensor. This sensor 122 may have a linear extent in the movement direction 66, or it may be coupled to a motor shaft of the motor 114, in order for it to be possible to detect the carriage position from the motor-shaft position. This sensor 122 can also allow, in particular, the end position of the carriage 64 to be determined. Via this sensor 122, it is possible, as is described in more detail hereinbelow, for the operation of feeding separating sheets to the cut slices 22 and a movement of the carriage 64 to be synchronized.

The separating-sheet dispenser 10 according to the invention functions as follows:

In order to produce a separating sheet 76, the carriage 64 is moved forwards in the direction of the transporting-roller device 48, so that the transporting rollers 50, 52 can grip separating material 57. The separating material 57 here is unrolled on the carriage 64, so that it is located in the region of the cutouts 78, 80.

During the forward movement of the carriage 64, which is driven by the motor 114, the cutting blade 84 is displaced into its high-level position by the rolling element 106 rolling up the ramp 100. The cutting blade is then located above the transporting rollers 50, 52.

The sensor 62 activates the motor 56 for rotating the transporting rollers 50, 52 such that the flattened region 58 of the transporting rollers 50, 52 is aligned parallel to the stop plate 14. The carriage 64 is then displaced by way of its recesses 78, 80 such that the transporting rollers 50, 52 and the respective counter elements 74 thereof can penetrate into the recesses 78, 80. During rotation of the shaft 54, the separating material between the transporting rollers 50 and 52 can then be gripped and retained between these transporting rollers and their counter elements 74.

The carriage 64 is then moved away from the transporting-roller device 48. Separating material is thus unrolled from the roll 72 and, at the same time, kept under tension. As long as the stop element 110 has not been reached, the cutting blade 84 remains in its high-level position with the spring 92 compressed.

When the stop element 110 is reached and the securing element 108 is released, then the cutting blade 84, under the action of the spring 92, drops in the direction of the unrolled separating material 57 and penetrates into the groove 94, cutting through the separating material 57 in the process. A separating sheet 76 is thus severed.

The length of the severed separating sheet 76 can be set by the stop element 110.

By virtue of the end position being reached, the sensor 118 and/or the sensor 122 generates a signal which indicates to a control and regulating device that the end position of the carriage 64 has been reached.

The separating-sheet dispenser 10 has then produced a separating sheet 76 which can be set down on a cut slice 22. This setting-down operation is synchronized with the operation of cutting such a cut slice 22: when a block 16 of foodstuff is cut and a cut slice is produced, as is indicated in FIG. 5, then, even during the cutting movement, the deflecting device 24 deflects the slice 22 from the cutting plane into a plane transverse thereto. In addition to the roller 38, for this purpose, the deflecting device 24 may also comprise a fixed deflecting element 124. By virtue of the deflecting element 124, the cut slice 22 is set down on the conveying device 26, where it is gripped, and as it were engaged, by the chain 32 and transported in the conveying direction 28.

During cutting, the separating-sheet dispenser 10 feeds a severed separating sheet 76 to the cut slice 22, in order for this separating sheet 76 to be set down thereon. The feeding operation takes place synchronously with the cutting movement. The separating sheet 76 is transported further via the transporting-roller device 48, to the deflection device 24 and is carried along there by the rollers 38 and set down on the cut slice 22. Between the cut slice 22, which contains fat, and the separating sheet 76, there is usually a sufficiently high force of adhesion prevailing in order for the separating sheet to be transported along by the cut slice.

The separating sheet is fed from the transporting-roller device 48 to the deflecting device 24 and, from there, is then set down on the cut slice 22.

The cut slices with separating sheets 76 set down thereon are then positioned on a tray, at the end of the conveying device 26, by a removal means (not shown in the figures). Since the cut slices 22 are set down with separating sheets clinging to them, it is possible to achieve different set-down patterns. For example, the cut slices 22 may be set down in the form of shingles, of a rosette or in stack form. By virtue of the removal means, a cut slice with separating sheet disposed thereon is set down with the separating-sheet side downwards.

During the operation of dispensing separating sheets to the cut slices 22, the carriage 64 moves in the direction of the transporting-roller device 48 again, in order for it to be possible to produce a new separating sheet 76. In this case, the cutting blade 84 is moved, once again, into its high-level position.

The movement of the carriage 64, the rotation of the transporting-roller device 48 for gripping the separating material and for passing on the separating material and the transfer to the deflecting device 24 are synchronized. Provided for this purpose is a control and regulating device which, synchronized with the cutting movement, ensures a corresponding movement of the carriage 64 and a rotation of the transporting-roller device 48. The sensors 82, 118 and/or 122 can control or monitor these movements.

By virtue of the control and regulating device, it is also possible to control whether a separating sheet is actually to be set down and when this is to take place. This can be set, for example, by a user.

It is also conceivable for a sensor for a material which is to be cut to determine the fat content before or during cutting. If it is established that the fat content is so high that there is a risk of cut slices which are set down one upon the other sticking together, then the control and regulating device can ensure that a separating sheet is set down on the respective cut slices.

In the case of the exemplary embodiment shown, the cutting movement of the cutting blade 84 is controlled automatically by mechanical means, so that there is no need for any electronic regulation here.

According to the invention, a severed separating sheet 76 is transferred from the transporting-roller device 48 of the deflecting device 24 in order for it to be possible for it to be set down, from there, on a cut slice 22.

1. A separating-sheet dispenser for providing separating sheets of a separating material for cut slices of foodstuff from a slicing machine, said slicing machine including a deflecting device for successively deflecting cut slices of foodstuff, the separating-sheet dispenser comprising:
a holder for said separating material;
a cutting device for producing said separating sheets from said separating material; and
a transporting device comprising at least one rotatable transporting roller for transporting said separating material;
the at least one transporting roller being positioned toward said deflecting device.

2. The separating-sheet dispenser according to claim 1, wherein the slicing machine further comprises a cutting plane, the deflecting device deflecting cut slices of foodstuff from said cutting plane into a plane transverse to the cutting plane.

3. The separating-sheet dispenser according to claim 1, wherein the deflecting device comprises a carry-along element for cut slices.

4. The separating-sheet dispenser according to claim 3, wherein the carry-along element is a rotatable element.

5. The separating-sheet dispenser according to claim 1, wherein the deflecting device is disposed and formed such that separating material advances along said deflecting device.

6. The separating-sheet dispenser according to claim 1, wherein the at least one transporting roller is adapted to feed a separating-sheet to a cut slice on the deflecting device.

7. The separating-sheet dispenser according to claim 1, wherein the at least one transporting roller and the deflecting device are adapted to transport a separating-sheet substantially adjacent a cut slice.

8. The separating-sheet dispenser according to claim 1, further comprising at least one rigid element disposed as at least one counter element on the transporting device and located opposite the at least one transporting roller.

9. The separating-sheet dispenser according to claim 1, wherein the separating-sheet dispenser feeds a separating-sheet to a cut slice as the cut slice is being cut from the foodstuff.

10. The separating-sheet dispenser according to claim 1, wherein the slicing machine further comprises a slicing apparatus disposed to slice cut slices from the foodstuff, the slicing apparatus and the transporting device operating synchronously.

11. The separating-sheet dispenser according to claim 1, wherein the slicing machine further comprises a blade for slicing cut slices from the foodstuff and a conveying device disposed to transport cut slices away from the blade.

12. The separating-sheet dispenser according to claim 11, wherein the conveying device comprises a chain frame.

13. The separating-sheet dispenser according to claim 11, wherein the at least one transporting roller is positioned facing the conveying device.

14. The separating-sheet dispenser according to claim 11, wherein the deflecting device is positioned facing the conveying device.

15. The separating-sheet dispenser according to claim 12, wherein the at least one transporting roller is adapted to feed successive separating sheets to successive cut slices disposed along the chain frame such that the separating sheets are disposed between the cut slices and the at least one transporting roller.

16. The separating-sheet dispenser according to claim 15, wherein the at least one transporting roller is adapted to feed successive separating sheets to the cut slices between the chain frame and the deflecting device.

17. The separating-sheet dispenser according to claim 1, wherein the deflecting device comprises a carry-along element adapted to pass a separating sheet from the at least one transporting roller to the carry-along element of the deflecting device.

18. The separating-sheet dispenser according to claim 17, wherein the carry-along element of the deflecting device comprises a rotatable element, the rotatable element and the at least one transporting roller having parallel axes of rotation.

19. The separating-sheet dispenser according to claim 11, wherein the slicing machine further comprises a circular blade for slicing said cut slices from said foodstuff, the blade having an axis of rotation, the conveying device defining a conveying direction of the cut slices away from the blade, the conveying direction being substantially parallel to the axis of rotation of the circular blade.

20. The separating-sheet dispenser according to claim 11, wherein the conveying device defines a conveying direction of cut slices, the conveying direction being substantially perpendicular to an axis of rotation of the at least one transporting roller.

21. The separating-sheet dispenser according to claim 11, wherein the conveying device defines a conveying direction for cut slices and the transporting device defines a general transporting direction for successive cut sheets, the at least one transporting roller being disposed and adapted to deflect successive separating sheets from the transporting direction to a direction substantially parallel to the conveying direction, the direction substantially parallel being substantially transverse to the transporting direction.

22. The separating-sheet dispenser according to claim 1, wherein the at least one transporting roller is driven.

23. The separating-sheet dispenser according to claim 1, wherein the at least one transporting roller comprises a planar region.

24. The separating-sheet dispenser according to claim 1, wherein the holder is adapted to accommodate a roll of separating material.

25. The separating-sheet dispenser according to claim 1, further comprising a linearly displaceable carriage, the holder being disposed on the linearly displaceable carriage.

26. The separating-sheet dispenser according to claim 25, wherein the carriage is guided such that it is displaceable relative to the at least one transporting roller.

27. The separating-sheet dispenser according to claim 25, wherein the carriage comprises at least one recess disposed relative to the at least one transporting roller whereby the recess facilitates gripping of the separating material by the transporting roller.

28. The separating-sheet dispenser according to claim 25, wherein movement of the carriage is driven.

29. The separating-sheet dispenser according to claim 25, wherein the carriage is displaceable in a direction transverse to an axis of rotation of the at least one transporting roller.

30. The separating-sheet dispenser according to claim 25, wherein the slicing machine further comprises a cutting blade and defines a conveying direction for cut slices, the carriage being displaceable away from the cutting blade in a direction transverse to the conveying direction.

31. The separating-sheet dispenser according to claim 25, wherein the slicing machine further comprises a circular blade for cutting said foodstuff, the circular blade having an axis of rotation, the carriage being displaceable transversely to said axis of rotation of the circular blade.

32. The separating-sheet dispenser according to claim 25, wherein the slicing machine further comprises a foodstuff carriage for accommodating foodstuff which is to be cut, the foodstuff carriage having a foodstuff carriage displacement direction, the linearly displaceable carriage being displaceable substantially parallel to the displacement direction of the foodstuff carriage.

33. The separating-sheet dispenser according to claim 25, wherein the slicing machine further comprises a stop plate for said foodstuff, and optionally comprising a plate disposed in a parallel relation to the stop plate, the carriage being guided on at least one of said stop plate and said plate.

34. The separating-sheet dispenser according to claim 25, wherein the slicing machine comprises a housing part, the carriage being guided on said housing part.

35. The separating-sheet dispenser according to claim 33, wherein the transporting device is mounted on at least one of the stop plate and the parallel plate.

36. The separating-sheet dispenser according to claim 35, wherein the deflecting device is mounted at a fixed spacing from the stop plate.

37. The separating-sheet dispenser according to claim 11, wherein the deflecting device is mounted on the conveying device.

38. The separating-sheet dispenser according to claim 25, wherein separating material is disposed between the at least one transporting roller and the holder as a result of linear displacement of the carriage.

39. The separating-sheet dispenser according to claim 25, wherein the slicing machine further comprises a cutting device coupled to the carriage.

40. The separating-sheet dispenser according to claim 39, wherein the cutting device comprises a cutting blade which is guided in a vertically displaceable manner on the carriage.

41. The separating-sheet dispenser according to claim 39, wherein the cutting device comprises a cutting blade and the carriage comprises a groove for the penetration of the cutting blade.

42. The separating-sheet dispenser according to claim 39, wherein the cutting device comprises a cutting blade and a positioning device to which the cutting blade is coupled, the positioning device being adapted to move the cutting blade to a high-level position, the positioning device being adapted to be fixed in and released from the high-level position such that release from the high-level position initiates a cutting movement of the cutting blade.

43. The separating-sheet dispenser according to claim 42, further comprising a ramp, the positioning device and the cutting blade being moveable to a high-level position by means of said ramp.

44. The separating-sheet dispenser according to claim 43, wherein the linearly displaceable carriage is linearly displaceable toward the transporting roller, the cutting blade and positioning device being movable along the ramp into said high-level position as the carriage is linearly displaced toward the transporting roller.

45. The separating-sheet dispenser according to claim 42, wherein the cutting device further comprises a spring, the cutting blade being biased by said spring.

46. The separating-sheet dispenser according to claim 42, wherein the cutting device defines a cutting plane along which the cutting blade moves in a cutting movement, the positioning device comprises a releasable stop for the carriage, and the separating material is provided in a roll, the separating material being disposed such that a length of the separating material may be unrolled to a position extending through said cutting plane, release of said stop initiating said cutting movement toward unrolled separating material whereby the cutting blade severs a separating sheet.

47. The separating-sheet dispenser according to claim 46, wherein the stop is displaceable and fixable in order to set a separating-sheet length.

48. The separating-sheet dispenser according to claim 25, wherein linear displacement of the carriage is synchronized with a separating-sheet dispensing operation.

49. The separating-sheet dispenser according to claim 48, wherein, the carriage is adapted to be displaced in a direction of the at least one transporting roller during said separating-sheet dispensing operation.

50. The separating-sheet dispenser according to claim 48, wherein the linearly displaceable carriage has an end position, and the dispenser further comprises a sensor disposed to detect at least said end position of the carriage.

51. The separating-sheet dispenser according to claim 50, further comprising a sensor disposed to determine at least the position of the carriage relative to the at least one transporting roller.

52. A slicing machine for providing cut slices of foodstuff, the slicing machine comprising a deflecting device for deflecting cut slices and a separating-sheet dispenser for providing separating sheets of a separating material, said separating-sheet dispenser comprising:
a holder for said separating material;
a cutting device for producing said separating sheets; and
a transporting device comprising at least one rotatable transporting roller for transporting said separating material;
the at least one transporting roller being positioned toward the deflecting device.

53. The slicing machine according to claim 52, further comprising a driven circular blade for producing said cut slices.

54. The slicing machine according to claim 52, further comprising a displaceable accommodating carriage for foodstuff which is to be cut.

55. The slicing machine according to claim 52, further comprising a stop plate for foodstuff which is to be cut.

56. A dispensing method for dispensing separating sheets between cut slices of foodstuff, the dispensing method comprising the steps of:
feeding successive separating sheets between a conveying device for cut slices and a deflecting device for cut slices to successive cut slices; and
depositing successive separating sheets on successive cut slices.

57. The dispensing method according to claim 56, further comprising the step of dispensing a separating sheet as a slice is being cut.

58. The dispensing method according to claim 56, wherein the step of feeding comprises the step of feeding separating material to the deflecting device via at least one transporting roller.

59. The dispensing method according to claim 58, wherein the step of feeding comprises the step of the transporting roller gripping separating material to unroll said separating material from a roll.

60. The dispensing method according to claim 59, wherein the step of gripping comprises the step of controlling an angular position of the at least one transporting roller such that the separating material can be gripped.

61. The dispensing method according to claim 59, further comprising the step of unrolling the separating material by moving a carriage with the roll away from the at least one transporting roller to unroll the separating material between the at least one transporting roller and the roll.

62. The dispensing method according to claim 61, further comprising the step of automatically cutting off a separating sheet from an unrolled portion of the separating material when the carriage reaches a given position.

63. The dispensing method according to claim 57, further comprising the step of successively cutting cut slices from said foodstuff, and wherein the steps of dispensing and feeding separating sheets are synchronized with the step of cutting cut slices.
